(19) United States
(12) Patent Application Publication
(10) Pub. No.: US 2008/0036133 A1
(43) Pub. Date: Feb. 14, 2008

(54) Saddle stitcher with individual stitcher drives

(75) Inventors: Glenn Alan Guaraldi, Kingston, NH (US); Warren Hess Jarrard, Farmington, NH (US)

Correspondence Address: DAVIDSON, DAVIDSON & KAPPEL, LLC, 485 SEVENTH AVENUE, 14TH FLOOR, NEW YORK, NY, 10018, US

(73) Assignee: Goss International Americas, Inc., Dover, NH (US)

(21) Appl. No.: 11/501,306

(22) Filed: Aug. 9, 2006

(51) Int. Cl. B42B 2/00

(52) U.S. Cl. 270/52.18

(57) ABSTRACT

A saddle stitching device including a saddle-back conveyor having a first printed product location and a second printed product location adjacent the first printed product location, a first stitcher adjacent the conveyor and driven by a first motor, and a second stitcher adjacent the conveyor and driven by a second motor.

### BACKGROUND

The present invention relates to post-press machinery, and more specifically to saddle stitchers.

U.S. Pat. No. 4,519,599 discloses simultaneous stitching of tandem sets of 1-up gathered signatures. A shuttle mechanism grips adjacent, consecutive unbound books on a saddle-type gathering conveyor and, in a single stroke, presents both unbound books at a saddle stitcher station for simultaneous binding.

U.S. Pat. No. 5,772,195 discloses a gathering and wire stitching machine for producing magazines, booklets and similar products from folded printed sheets comprising a conveyor path including a gathering segment and an adjoining wire stitching segment, the conveyor path including a saddle-shaped support for receiving printed sheets in a straddling arrangement from feeders arranged along the gathering segment.

U.S. Pat. Nos. 4,708,277 and 4,196,835 disclose stitching devices and are hereby incorporated by reference herein.

### SUMMARY OF THE INVENTION

The present invention provides a saddle stitching device comprising:
a saddle-back conveyor having a first printed product location and a second printed product location adjacent the first printed product location;
a first stitcher adjacent the conveyor and driven by a first motor; and
a second stitcher adjacent the conveyor and driven by a second motor.

By providing two individual motors, the stitchers can be driven independently and as desired.

The present invention also provides a method of saddle stitching printed products comprising:
conveying an unstitched first printed product using a conveyor past a first stitcher;
stitching the first printed product with the first stitcher, the first stitcher being driven by a first motor;
conveying an unstitched second printed product using the conveyor past the first stitcher without stitching the second printed product to a second stitcher; and
stitching the unstitched second product with the second stitcher, the second stitcher being driven by a second motor.

### BRIEF DESCRIPTION OF THE DRAWINGS

FIG. 1 shows a saddle stitcher according to the present invention stitching a first product; and

FIG. 2 show a saddle stitcher according the present invention stitching a second product.

### DETAILED DESCRIPTION OF A PREFERRED EMBODIMENT

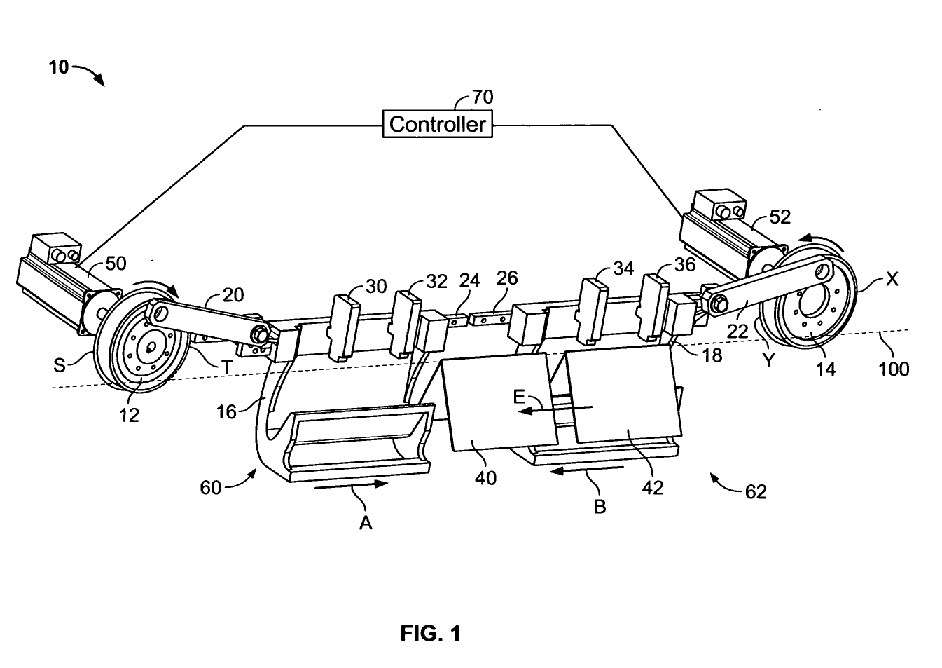

FIG. 1 shows a stitcher 10. Stitcher 10 includes two stitchers 60 and 62, each driven by its own motor, i.e. independently. Stitcher 60 includes a motor 50 that drives a wheel 12. A carriage 16 is mounted on a bearing slide 24 and connected to wheel 12 by a link 20. Mounted onto carriage 16 are reciprocating stitching heads 30, 32. Any number of stitching heads may be provided, although two or three are preferable.

Stitcher 62 includes a motor 52 that drives a wheel 14. A carriage 18 is mounted on a bearing slide 26 and connected to wheel 14 by a link 22. Mounted onto carriage 18 are reciprocating stitching heads 34, 36. A controller 70 controls motors 50, 52. A first signature 40 and a second signature 42 at adjacent printed product receiving locations on a saddle-back conveyor 100 travel in a direction E across carriages 16 and 18.

The stitchers 60, 62 advantageously are not fastened together, so that they are free to move independently of each other.

Motors 52, 62 preferably are servomotors, and are capable of being phase-controlled.

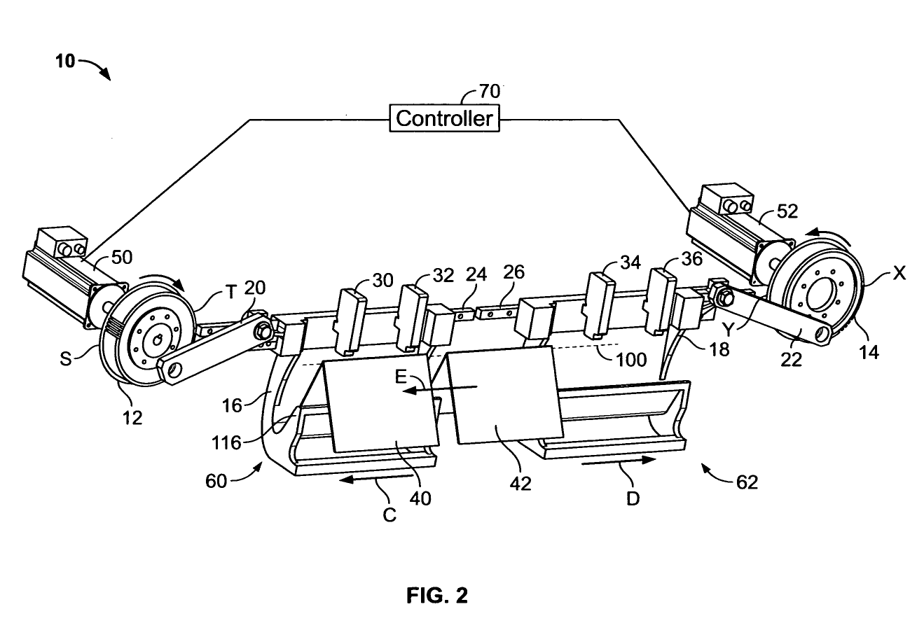

In the embodiment of FIGS. 1 and 2, when stitcher 62 receives a signal from controller 70, motor 52 drives wheel 14 in a counterclockwise direction. Link 22, rotatably connected to wheel 14 on one end and carriage 18 on another, rotates with wheel 14. As wheel 14 rotates counterclockwise from a point X to a point Y, carriage 18 is propelled in a direction B along bearing slide 26. Carriage 18 moves in the same direction as signatures 40, 42. When a speed of carriage 18 nears a speed of signatures 42 and stitching heads 34, 36 are positioned properly, stitching heads 34, 36 are actuated and stitch signature 42. Stitching heads 34, 36 may move up and down to stitch signature 42.

Incorporated-by-reference U.S. Pat. No. 4,196,835 for example shows the details of the stitcher assembly or stitchers 50, 60, as well as the clinchers 116.

When stitcher 60 receives a signal from controller 70, motor 50 drives wheel 12 in a clockwise direction. Link 20, rotatably connected to wheel 12 on one end and carriage 16 on another, rotates with wheel 12. As wheel 12 rotates clockwise from a point S to a point T, carriage 16 is propelled in a first direction A along bearing slide 24, opposite to direction E in which signatures 40, 42 travel, so stitching heads 30, 32 do not yet stitch signature 40.

FIG. 2 shows stitcher 10 after wheels 12, 14 have rotated approximately 180 degrees. As wheel 14 continues to rotate from Point Y to Point X, link 22 pulls carriage 18 in direction D. Stitching heads 34, 36 are no longer in the position to stitch. As wheel 12 continues to rotate from Point T to Point S carriage 16 is propelled in a direction C along bearing slide 24. Now, carriage 16 moves in the same direction as signatures 40, 42. When a speed of carriage 16 nears a speed of signatures 40 and stitching heads 30, 32 are positioned properly, stitching heads 30, 32 are actuated and stitch signature 40. Stitching heads 30, 32 may move up and down to stitch signature 40.

The stitching heads may move up and down to stitch and back and forth in the direction of the saddle back conveyor as carriages oscillate, as described un U.S. Pat. No. 4,196,835.

The stitchers 60, 62 may be set to stitch approximately 180 degrees out of phase from each other, for example. However, depending on spacing and timing and the number of stitchers for example, stitchers may be run in phase at the same time, or at different phases than 180 degrees. This is achievable since the stitchers have independent drive motors and the controller 70 can set the phasing of the motors.

What is claimed is:

1. A saddle stitching device comprising:
a saddle-back conveyor having a first printed product location and a second printed product location adjacent the first printed product location;
a first stitcher adjacent the conveyor and driven by a first motor; and
a second stitcher adjacent the conveyor and driven by a second motor.

2. The saddle stitching device as recited in claim 1 further comprising a controller controlling the first motor and the second motor.

3. The saddle stitching device as recited in claim 2 wherein the controller controls the phase of the first motor with respect to the second motor.

4. The saddle stitching device as recited in claim 1 wherein the first stitcher includes at least two stitching heads and the second stitcher includes at least two other stitching heads.

5. The saddle stitching device as recited in claim 2 wherein the controller controls the first and second motor so that the first stitcher stitches at the first printed product location but not the second printed product location and the second stitcher stitches at the second printed product location but not the first printed product location.

6. A method of saddle stitching printed products comprising:
conveying an unstitched first printed product using a conveyor past a first stitcher;
stitching the first printed product with the first stitcher, the first stitcher being driven by a first motor;
conveying an unstitched second printed product using the conveyor past the first stitcher without stitching the second printed product to a second stitcher; and
stitching the unstitched second product with the second stitcher, the second stitcher being driven by a second motor.
